(19) United States
(12) Patent Application Publication
(10) Pub. No.: US 2025/0085943 A1
(43) Pub. Date: Mar. 13, 2025

(54) OPTIMIZING INSTRUCTION SCHEDULING AND MEMORY ALLOCATION FOR TENSOR AND GRAPHICAL PROCESSORS USING LATTICE IMAGE DATA STRUCTURE OPTIMIZATIONS

(71) Applicant: Groq, Inc., Mountain View, CA (US)

(72) Inventor: Samir Jindel, Wexford, PA (US)

(21) Appl. No.: 18/465,492

(22) Filed: Sep. 12, 2023

(51) Int. Cl. G06F 8/41

(52) U.S. Cl. CPC G06F 8/452

(57) ABSTRACT

Optimizing instruction scheduling and memory allocation for tensor and graphical processors using lattice image data structure optimizations is provided. A method of using a loop fusion by a compiler in interconnected accelerator units to simplify a machine learning (ML) graph representing a program to be compiled is provided. The method includes (A) lowering a plurality of operations in an initial first program to an original plurality of at least two loops. The method also includes (B) inferring a fused loop structure from the original plurality of at least two loops in the initial first program thus creating a second program having the fused loop. The fused loop in the second program is pipelining the multiplication and addition operations thus significantly reducing the memory bandwidth requirements and improving cache locality.

### ABSTRACT

Methods are provided using lattices (representing graph data structures that encode a machine learning application program) and lattice images and algorithms to accelerate optimization problems that arise during the mapping of tensor processing algorithms to specialized processors, such as for machine learning (ML) or artificial intelligence (AI), optimizations such as the scheduling of instructions and the allocation of memory. These optimizations are obtained with improved compiler methods that use lattice image and transformation algorithms to accelerate, among other tasks, memory partitioning, operation splitting, loop fusion, and optimal allocation of intermediate results of matrix mathematical operations.

### COPYRIGHT NOTICE

This patent document can be exactly reproduced as it appears in the files of the United States Patent and Trademark Office, but the assignee(s) otherwise reserves all rights in any subsets of included original works of authorship in this document protected by 17 USC 102 (a) of the U.S. copyright law.

### SPECIFICATION-DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s). A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

The present disclosure generally relates to compiler operations, and more specifically to computer compiler technology for using lattice transformations of program instruction and data flow graphs for graphical and tensor processors.

### BACKGROUND

The latest machine learning (ML) and high performance computing (HPC) algorithms, such as for text and image generation, data classification and prediction, and natural language processing, require one or more processors executing billions and trillions of operations per second (if not more), performing mathematical calculations on gigabytes of data. Typically, the mathematical calculations are multiplications involving vectors and matrices or higher-dimensional arrays of data (all collectively referred to as ‘tensors’). Such processors include graphical processing units (GPUs), tensor processing units (TPUs), and field programmable gate arrays (FPGAs). One type of TPU is the tensor streaming processor (TSP) available from Groq. Inc. (Mountain View, California).

The heightened computational requirements of these algorithms, many of which involve very large numbers of vector and matrix calculations on very large arrays of numerical data (we will only refer to matrices below, but all of the embodiments apply to tensors as well), require new optimizations for the sequences of instructions generated by the compiler for both calculations (for example, loop unrolling, transformation, and fusion) and data transfers (for example, memory allocation, splitting, reuse and reduction).

For many processors, a compiler transforms a machine learning algorithm into a graph data structure, such as an Open Neural Network Exchange (ONNX) graph. The compiler can then transform the ONNX graph into an intermediate data structure more useful for generating the specific sequences of processor instructions and data transfers to execute the ML algorithm on one or more processors. One such intermediate data structure is based on the MLIR (machine learning intermediate representation) standard. After the MLIR data structure is generated by the compiler front-end, the compiler back-end can then use it to generate an instruction sequence specific to the type or model of processor, which specifies the placement of data and timing of operations during the execution of the ML algorithm on the processor.

Typically, a 2D matrix is indexed by integers, M (i,j,k . . . ), where the indices i,j,k range from 1 to the corresponding dimension of the array. For an n-by-n matrix, i and j both can range from 1 to n. Computations are performed on all or part of a matrix using loop instructions (for example, the ‘for’ and ‘while’ instructions in languages such as C and Fortran). A loop over two or more dimensions of a matrix is referred to as a ‘nested loop’ or a ‘loop nest’. If the index calculations are linear functions of the indices and constant integers (for example, M [2*i+1, j]=P [j, 3*i−2], then the loop nest is referred to as ‘affine loop nest’.

Many engineering calculations, such as finite element methods, and machine learning, use affine loop nests. One goal of compilers is to generate instructions that most efficiently perform the calculations of these nested loops. One or more contiguous loop nests in a region of code are often referred to as a ‘kernel’.

Historically, there are two broad classes of approaches used to optimize the tensor program kernels: a mostly manual process, and the polyhedral process (mostly automated). Many prior techniques in tensor compilation focus on optimizing individual “kernels” of computation.

Kernel developers (specialized programmers with intimate understanding of the target processor) will program and tune optimized codes for common groups of operations found in the kernels of ML program graphs. Optimizing kernels often involves representing the loop bounds and strides with integer sets and lattices, and prior algorithms optimize aspects like cache locality or memory allocations for these individual kernels.

It is challenging to apply the kernel-focused approach to ML programs, which typically contain a large number of simple operators. A kernel-based compiler will attempt to match groups of operations from an input ML program graph against a predefined library of kernels, and replace the original group of operations with the complex operation defined by the kernel code. Efficient compilation of ML programs requires combining many operators into single kernels; however, creating these kernels automatically is a challenging problem, and compiling ML programs without kernels is an even more complicated problems that other skilled engineers have failed to solve.

While the kernel-based approach with sufficient manual labor enables a compiler to produce high throughput programs, it is inflexible in handling varied types of tensor program graphs (a.k.a “model architectures”). This requires a lot of manual labor to enable new types of model architectures to run on a processor, as well as to adapt a library of optimized kernels for a new processor model. Some systems like OpenAI's Triton apply machine learning to automatically tune the parameters of these kernels, but still require manual work to identify and define the operation groups the kernels apply to and the loop structure of the kernel codes themselves. And none of these approaches result in kernel-less compilations, that is, where the some or all of the loops are broken up and/or combined to run most efficiently on a high-speed processor.

The kernel-based approach also results in sub-optimal latency, since the compiler is unable to coordinate the execution of instructions across different kernels. To extract high performance from this approach, each kernel typically processes a “batch” of multiple inputs simultaneously, so that the time spent processing each individual kernel is long enough to dwarf the time spent synchronizing data flows between kernels which can require loading/storing to off-processor memory. However, this results in a longer start-to-finish time (latency) for each individual input.

POLYHEDRAL. The polyhedral approach uses the mathematics of lattices and rational polyhedra to transform the program code into a more abstract representation, applies mathematical optimizations on the polyhedral representation, then transforms back to more optimized program code. The polyhedral model was historically used for optimization of classical ML, HPC (high-performance computing) and scientific programs, which tend to contain a small number of complex and manually-coded mathematical operations. The polyhedral model has fallen out of use in the context of contemporary ML/AI compilation due to several issues.

As an example of a compiler using polyhedral optimization, consider the following snippet of code: const int n=100;

```
const int n = 100;
int i, j, a[n][n];
for (i = 1; i < n; i++) {
  for (j = 1; j < (i + 2) && j < n; j++) {
    a[i][j] = a[i − 1][j] + a[i][j − 1];
  }
}
```

The inner loop addition for a row i using a[i] [j] requires results from calculations on the previous row, a[i] [j-1] (the last term in the above equation). This loop cannot be parallelized to allow all rows to be processed at the same time. For a 1000-by-1000 array, a speed-up of 1000 is denied. But if the compiler can determine that the affine transformation (i′,j′)=(i+j, j) applied to the code removes the row dependency, the compiler can generate the program code that allows the inner loop on j:

$$a [ i ] [ j ] = a [ i - 1 ] [ j ] + a [ i ] [ j - 1 ] ;$$

to be transformed into instructions that can be performed in parallel:

$$a [ i - j ] [ j ] = a [ i - j - 1 ] [ j ] + a [ i - j ] [ j - 1 ] ;$$

The polyhedral model has two significant problems.

First, the polyhedral model uses the mathematics of lattices and rational polytopes to model patterns such as memory allocation or instruction scheduling of program codes. These discrete, integral mathematical structures cannot directly represent the non-deterministic elements of computer architectures such as CPUs, GPUs and TPUs, which include components like hardware-managed memory caches, DRAM (Dynamic Random-Access Memory), hardware data prefetching, and others. Accurate modeling of these components requires probabilistic mathematics, which are outside the scope of the polyhedral model (and are very challenging to use). Deterministic computer architectures like FPGAs (Field Programmable Gate Arrays) and TSPs avoid non-deterministic components and are therefore a better fit for this model.

Second, the polyhedral model is primarily effective at optimizing codes for individual mathematical operations but struggles with optimization tasks that span multiple mathematical operations. The reason for this relates to the “computational complexity” of these optimization tasks. Computational complexity measures the minimum quantity of a computational resource (typically time) required to solve an algorithmic problem. Most optimization tasks in the polyhedral model reduce to a type of algorithmic problem called Integer Linear Programming (ILP), where the solutions to variables in the equations are restricted to integers. The computational complexity of solving an ILP problem is exponential in its dimension (number of variables). If the number of variables is sufficiently large (often, larger than just 20), the time required to solve the ILP is untenably long. When optimizing properties of an individual operation in a tensor program graph, the number of variables is typically low; however, when performing optimizations across a chain of many operations, the number of variables can become intractably large. This impedes the application of polyhedral optimizations to modern tensor programs, which are usually defined by long chains of many simple operations (in contrast to traditional ML/HPC program codes, which are dominated by a few complex operations). Optimizing each of these simple operations independently is insufficient to extract peak performance from a modern tensor program graph.

There are a wide variety of methods to implement polyhedral optimization inside of compilers. One approach is to use a data structure referred to as an ‘integer set’, which is basically a set of integers with affine (e.g., linear) constraints. Associated with integers sets are integer maps, which are binary relations between integer sets also with affine constraints. That is, the relations between integers in an integer set, and between two integer sets, are all linear functions (such as in the above example). Indeed, integer sets are so useful in compiler technology, that a standardized library of C source code for integer set manipulation is available (including algorithms for Integer Linear Programming), the Integer Set Library (ISL), used, for example, in the extremely popular GCC compiler family, and integrated with the LLVM tool set that is the foundation for many compiler front-ends and back-ends.

The polyhedral model uses ‘rational polygons’ and Presburger arithmetic to characterize integer sets and relations, respectively. Typically, the integer sets are used to represent loop bounds, while integer relations model data or temporal dependencies between instructions. For example, consider a loop nest in C that represents a N×N times N×N matrix multiplication C=A*B.

| for (int i = 0; i < N; ++i) { | // Row of the left matrix. |
|---|---|
| for (int j = 0; j < N; ++j) { | // Column of the right |
| matrix. | |
| C[i, j] = 0; | |
| for (int k = 0; k < N; ++k) { | // Column/row of the |

```
left/right matrix
      C[i, j] += A[i, k] * B[k, j];
    }
  }
}
```

In this loop nest, the inner-most loop is computing the vector dot product between row i of the left matrix A and column j of the right matrix B. Since these are separate matrices with possibly independent data, result C depends on each pair of vectors (i,j). Therefore, the iteration space of the outer two loops forms a square. Suppose instead that we are computing the matrix product of A with itself (C=A*A):

| | |
|---|---|
| for (int i = 0; i < N; ++i) { | // Row of the left matrix. |
| for (int j = 0; j < i; ++j) { | // Column of the left |

```
matrix.
    C[i, j] = 0;
    for (int k = 0; k < N; ++k) {
      C[i, j] += A[i, k] * A[k, j];
    }
    C[j, i] = C[i, j];
  }
}
```

Now, instead of computing the vector dot product between each pair (i,j), since the vector dot product is symmetric, we only need to compute each pair (i,j) where i<j, since the pair (j,i) will have the same result. The set of points (i,j) which the outer two loops cover now forms a triangle. More generally, the set of points covered by an arbitrarily deep loop nest in this model will form a polygon.

The polyhedral model uses Presburger arithmetic to represent most complex integer relations. Presburger arithmetic is an arithmetic system that allows addition of any two terms, and multiplication, modulo, and division by constants only. The above matrix multiplication example contains very simple relations between A, B and C. For a more interesting example, consider a chain of operations Subview=>Reshape, where the Subview operation is selecting a subset of the elements of an input matrix, and the Reshape relation reorganizes the position of the elements between the rows and columns (note that Reshape is not the same as a matrix transpose) as depicted in FIG. 1.

On the top are illustrated the simplified Presburger relations (between integer sets of tensors indices) modeling each operation separately, and on the bottom is the simplified composed relation that describes the relationship between elements of the input to the chain and elements of the result. Note that the bottom formula is significantly longer than either of the two input formulas. In general, the size of a simplified formula generated by composing Presburger relations can be exponential in the number of relations composed together. For example, in a chain of N operations, the relation modeling the dependence between inputs of the chain and outputs of the chain could have length 2N. Generally, optimal algorithms for solving ILP problems are also exponential in the number of variables in the problem. When modeling a Presburger formula within an ILP, it is necessary to add a number of variables to the ILP proportional to the length of the Presburger formula.

FAILURE TO OPTIMIZE FOR KERNEL-LESS COMPILERS. The computational complexity of solving an ILP problem on a composed Presburger relation can be up to doubly exponential in the number of chained relations. This frustrates optimization tasks in a kernel-less compiler which need to solve problems like memory allocation or instruction scheduling across long chains of operations, instead of on single fused kernels.

### Current Approaches for Polyhedral Kernel Optimization

Polyhedral Compilation, Integer Sets, Presberger, ILP. In a paper, “Polyhedral Compilation and the Integer Set Library”, Sven Verdoolaege of Cerebras Systems discusses the company's use of polyhedral compilation, integer sets, Presberger arithmetic and integer linear programming in the compilers for its high-speed processor for sparse linear algebra (a subset of tensor processing). The techniques in this paper are used by a compiler to optimize kernels that are identified in earlier stages of compilation. Thus, it is mostly restricted to optimization within one kernel, instead of optimization across multiple kernels that can result in kernel-free code generation that optimally uses an extremely high-speed processor architecture (such as the streaming TSP processor). The paper discusses arbitrary rational polyhedra optimization that can be enabled by the ISL, but this is of lesser utility for ML algorithms.

Tensor Comprehensions. In a paper, “The Next 700 Accelerated Layers: from Mathematical Expressions of Network Computation Graphs to Accelerated GPU Kernels, Automatically”, a team at Facebook describes the use of Tensor Comprehensions to automatically generate kernels. Tensor Comprehensions are an algorithmic notation for operations on tensors that makes it easier for the compiler to optimize transformations for nested loops of operations on the tensors, using a polyhedral compiler to optimize tensor operations. The optimizations are mostly restricted to optimization within one nested loop/kernel, and not allowing optimizations across multiple nested loops, which would result in kernel-free operations. Additionally, the Facebook approach does not work well for Reshape and Resize operations that arise in ML algorithms, which mix dimensional terms of the tensors and greatly complicate compilation.

Lattice data structures. Another approach for polyhedral optimization inside of compilers is the use of lattice data structures. Some of the first descriptions of this approach are seen in two papers, “Lattice-based memory allocation”, by Alain Darte et alia at the Ecole Normale Superieure de Lyon. April 2004, and “Bee+Cl@k: an implementation of lattice-based array contraction in the source-to-source translator ROSE”, also by Darte and published in 2007, which uses mixed integer linear programming to find optimal lattices for memory allocation. When large matrices are being multiplied, when elements of the matrix have already been used in the multiplication process, and are no longer needed, it is more efficient to reuse the space used by those elements to store new elements of the matrix to be multiplied.

However, optimizing just the placement of data is not efficient enough to use all of the computational power of a high-speed processor. What is needed as well is the optimal scheduling of instructions, for example restructuring the order of multiplications inside of a loop. Others have failed to schedule both the scheduling of data and instructions.

### SUMMARY

This Summary, together with any Claims, is a brief set of signifiers for at least one ECIN (which can be a discovery, see 35 USC 100 (a); and see 35 USC 100 (j)), for use in commerce for which the Specification and Drawings satisfy 35 USC 112.

In some embodiments of claimed inventions (ECINs), a compiler process reduces the number of variables in the program code representing relations of operations across long chains of tensor program operations such that the use of kernels at the lowest levels of program compilation can be eliminated. In some ECINs, a data structure, a ‘lattice image’, represents these relations in a tensor program code, and an algorithm, KCA (described below), is used to combine these relations while minimizing dimensionality of the integer sets and lattice images. These ‘lattice relations’ are then be used to automatically model features of the tensor program code in optimization tasks like instruction scheduling and memory allocation, without significantly increasing the number of variables in those optimization problems, and without requiring manual or automatic partitioning of the program into pre-defined kernels.

In some ECINs, a compiler combines data structures representing integer relations which model chains of operations in tensor program graphs up to 10 or 20 operations deep, or longer, while reducing the number of variables involved in these relations by orders of magnitude relative to prior art. Otherwise, these chains of operations can grow exponentially, rendering the program computationally intractable and expensive.

In some ECINs, a compiler optimizes across multiple nested loops in a tensor algorithm, while allowing for dimensional mixing that arises in operations such as tensor reshaping, resizing, convolution, and transposition, a utility missing from most existing polyhedral compilation techniques. This is important in some commercially lucrative applications, such as generative large language models that use tensor reshaping in their calculations. Being able to optimize, especially kernel-free, such reshaping operations will be of great benefit in commerce.

In some ECINs, a compiler for a deterministic streaming processor uses knowledge of the hardware configuration of the deterministic streaming processor to synchronize the timing of data and instruction flows such that corresponding data and instructions are received at each computational element with a predetermined temporal relationship (e.g., during the same clock cycle, separated by a predetermined delay, etc.).

In some ECINs, the predetermined temporal relationship may be based upon the hardware of the deterministic streaming processor, a type of instruction, and/or the like. Because the temporal relationship between data and instructions are known by the compiler, the operand data received by a computational element does not include any metadata indicating what the data is to be used for. Instead, each computational element receives instructions, and based upon the predetermined timing, performs the instruction on the corresponding data. This allows for the data and instructions to flow through the deterministic streaming processor more efficiently.

### DRAWINGS

The following Detailed Description, Figures, and Claims signify the uses of, and progress enabled by one or more ECINs. All the Figures are used only to provide knowledge and understanding and do not limit the scope of any ECIN. Such Figures are not necessarily drawn to scale.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

FIG. 1 illustrates simplified Presburger relations between integer sets of tensors indices modeling each operation separately and a simplified composed relation that describes the relationship between elements of the input to the chain and elements of the result.

FIG. 2 depicts an ECIN where hidden dimensions constrained via rectangular bounding boxes.

FIG. 3 depicts an ECIN where representation of the hidden dimensions explicitly defines a set of equality constraints.

FIG. 4 depicts a flowchart of the KCA algorithm in accordance with an ECIN.

FIG. 5 depicts a commutative diagram in accordance with an ECIN.

FIG. 6 depicts an equivalent to the KCA problem statement in accordance with an ECIN.

FIG. 7 depicts a simple processor architecture.

FIG. 8 depicts a lattice relation where a compiler needs to distribute data being summed is appropriately spread across the memory banks to feed a functional unit in accordance with an ECIN.

FIG. 9 depicts a sharding pattern of a matrix A where a compiler needs to distribute data being summed is appropriately spread across the memory banks to feed a functional unit in accordance with an ECIN.

FIG. 10 shows an arrangement of functional slices in a TSP, in accordance with some embodiments.

FIG. 11 illustrates an example TSP architecture, in accordance with some embodiments.

FIG. 12 illustrates organization and data flow within a row of a TSP, in accordance with some embodiments.

FIG. 13 is an abstract diagram of an example computer system suitable for enabling embodiments of the claimed disclosures for use in commerce, in accordance with an ECIN.

FIG. 14 is another abstract diagram of an example computer system suitable for enabling embodiments of the claimed disclosures for use in commerce, in accordance with an ECIN.

FIG. 15 illustrates an additional example computing machine for use in commerce, in accordance with an ECIN.

FIG. 16 depicts a block diagram of an exemplary compiler in accordance with an ECIN.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures, or compositions disclosed by such embodiments and/or examples are easily used in commerce. The Figures and Detailed Description signify, implicitly or explicitly, advantages and improvements of at least one ECIN for use in commerce. In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined for presentation and for illustration purposes and not be specified in detail. To not diminish the significance of these embodiments and/or examples, some well-known processes, machines, systems, manufactures, or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

### First Embodiment

In some ECINs, the hidden dimensions of an integer set (which represent the loop bounds and strides with integer sets and lattices) or relation are represented explicitly. The compiler defines the set of points in the integer set/relation as the image of those hidden dimensions under a (possibly non-injective) linear or affine map. This set of points is referred to as a ‘lattice image’. Moreover, in contrast to prior approaches, the compiler applies constraints (e.g., inequality constraints) to the hidden dimensions directly, rather than to the result of the linear/affine map, to combine these relations while minimizing dimensionality of the integer sets and lattice images. This can be visualized as follows (sets in the left diagram, relations in the right), for hidden dimensions which are constrained via rectangular bounding boxes as depicted in FIG. 2.

### Equality Constraints Define a Lattice

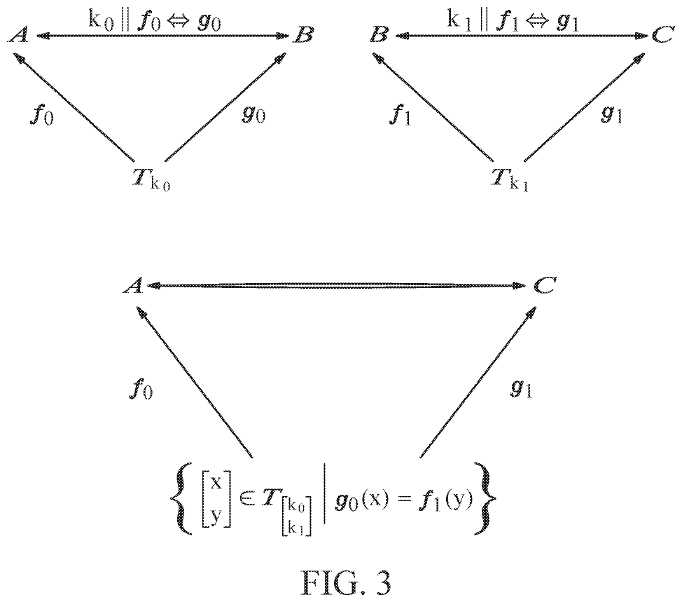

An essential benefit of representing these hidden dimensions explicitly is that problems like the composition of relations or set intersection can be defined by a set of equality constraints as depicted in FIG. 3.

These equality constraints allow the compiler to represent the composition of lattice images via a lattice, and using a standard algorithm like Hermite Normal Form, the compiler can compute a basis (injective linear map) for this composition. That the compiler can determine an injective map through these equality constraints between the hidden dimensions is an essential benefit of the Kernel Characterization Algorithm.

### Infer Latent Shape With Lattice Transformations (KCA)

In addition to the equality constraints (lattice basis), the hidden dimensions are also constrained by the constraints implied from their original relations (Tₖ₀ and Tₖ₁ in the visual above). The intended result of the KCA algorithm is to determine the latent shape of the lattice points within these axis-aligned bounds by applying lattice transformations.

The KCA algorithm iteratively seeks the minimally-dimensional shape of lattice points from the hidden dimension set, thus reducing the hidden dimension of the resulting set or relation. Similar to other lattice basis transformation algorithms, the algorithm iteratively modifies the starting lattice basis until a desired shape is achieved. This shape is mapped into a more efficient sequence of mathematical instructions for the processor. The following two steps comprising the KCA algorithm are run iteratively:

1) Validate a candidate shape or find missing points. Due to the injective nature of the lattice basis, each point in the lattice is defined by exactly one linear combination of lattice basis vectors. This means that the task of proving that all hidden points are covered by the inferred shape can be reduced to finding a lattice point for which one of the dimensions is outside the candidate coefficient bounds. The greater efficiency here is that the task of ensuring hidden points are covered can be framed as an existentially-quantified problem, rather than a universally-quantified problem, and therefore can be solved by ILP.

2) Use the missing points to improve the lattice basis. An objective function is applied to the ILP in the prior task to ensure that the discovered point will be a member of the desired basis. Then, the candidate basis is transformed via unimodular matrices such that the coefficients of the basis defining the point contain a 1, and the point can be swapped into the basis without altering the lattice it defines.

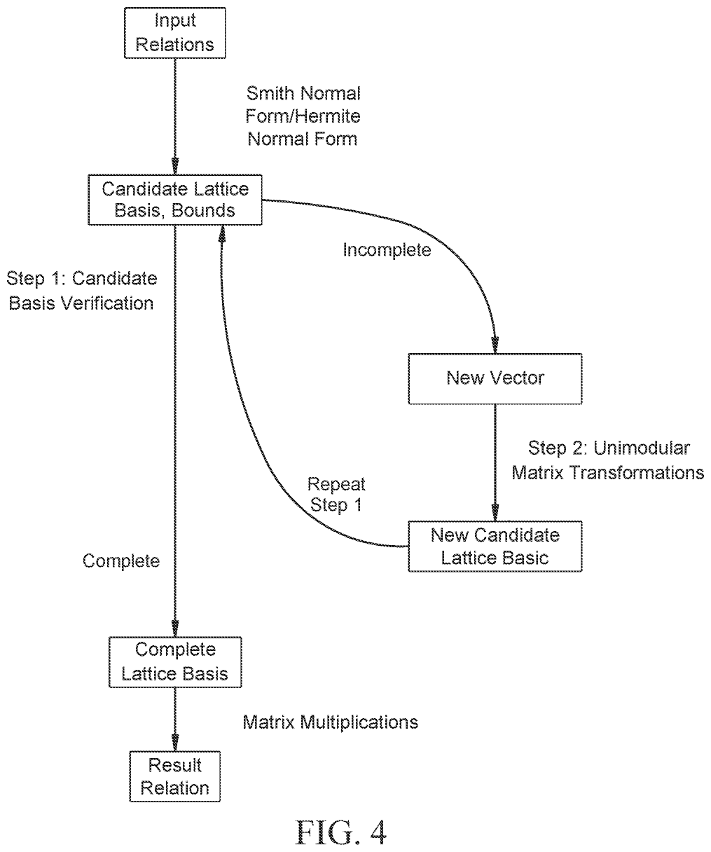

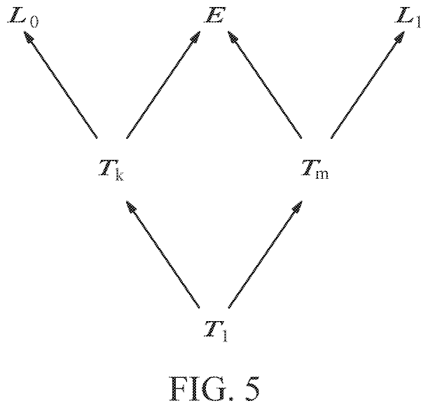

These are operations are visualized in the flowchart depicted in FIG. 4.

### Example Application: Loop Fusion

Loop fusion (loops of mathematical operations) is an essential part of many ML/HPC compilers, as it is required to extract competitive performance on many traditional architectures (CPU, GPU, etc.) As an example of loop fusion, consider the following ML graph, with input vectors A and B of dimension 1000000, and output D (vectors and matrices below assumed comprise 32-bit floating point numbers):

| | |
|---|---|
| A : | vector<1000000> |
| B : | vector<1000000> |
| C = | A * 0.8 |
| D = | C + B |

If each operation producing C and D is implemented as individual loops, the following program might result:

```
for (int i = 0; i < 1000000; ++i)
  C[i] = A[i] * 0.8;
for (int i = 0; i < 1000000; ++i)
  D[i] = C[i] + B[i];
```

Contrast that program with this one that is enabled as loop fusion:

```
for (int i = 0; i < 1000000; ++i) {
  C[i] = A[i] * 0.8;
  D[i] = C[i] + B[i];
}
```

Many compilers can enable the second program to be much faster, up to twice as fast, on most architectures. The reason is that the fused loop in the second program is pipelining the multiplication (A*0.8) and addition (C+B) operations, significantly reducing the memory bandwidth required and improving the cache locality of B. Moreover, the new loop structure makes it easy to eliminate the array B entirely, if there are no references to B outside the loop.

In the above example, it is not that complicated for many compilers to detect and enable the fused loop structure given the original pair of loops. However, in more complicated programs this may be challenging. Consider this graph:

| | |
|---|---|
| A : | tensor<4x6> |
| B : | tensor<6x> |
| C : | tensor<12x> |
| D = | A * B |
| E = | reshape(A, [2, 12]) |
| F = | C + E |

Expressed naively as loops, this program might look like this:

```
for (int i = 0; i < 4; ++i)
  for (int j = 0; j < 6; ++j)
    D[i, j] = A[i, j] * B[j];
for (int i = 0; i < 4; ++i)
  for (int j = 0; j < 6; ++j)
    E0[i * 6 + j] = D[i, j];
for (int i = 0; i < 2; ++i)
  for (int j = 0; j < 12; ++j)
    E1[i, j] = E0[i * 12 + j];
for (int i = 0; i < 2; ++i)
  for (int j = 0; j < 12; ++j)
    F[i, j] = E1[i, j] + C[j];
```

The first loop (D-A*B) and last loop (F=E1+C) execute the addition and multiplication operators, while the middle two loops are transforming the data layout according to the reshape. It is easy for a compiler to fuse the first two loops and the last two, since the variables i and j loop over the same integers. This might result in a program like the following (eliminating the temporary arrays D and E1):

```
for (int i = 0; i < 4; ++i)
  for (int j = 0; j < 6; ++j)
    E[i * 6 + j] = A[i, j] * B[j];
for (int i = 0; i < 2; ++i)
  for (int j = 0; j < 12; ++j)
    F[i, j] = E[i * 12 + j];
```

However, it is not obvious how to relate the induction variables between the two nests in order to fuse them into a single loop nest. In fact, there is no way to fuse the loop nests into a single depth-2 loop nest without using division or modulo operators in the indexing calculations, which are slower to execute on most architectures.

To apply loop fusion in this example, the indexing logic in the loops can be expressed as lattice relations. Using our syntactic shorthand:

| // loop 1 | |
|---|---|
| load A: | [4, 6] (a, b) ⇔ (a, b) |
| load B: | [4, 6] (a, b) ⇔ (b) |
| store E: | [4, 6] (a, b) ⇔ (6a + b) |
| // loop 2: | |
| load E: | [2, 12] (a, b) ⇔ (12a + b) |
| store F: | [2, 12] (a, b) ⇔ (a, b) |

In order to fuse the loops, the compiler needs to calculate the hidden dimensions of the bijection between the iteration spaces of the two loops. Mathematically, this is equivalent to computing the pullback between the load and store relations on E, visualized using a commutative diagram as depicted in FIG. 5.

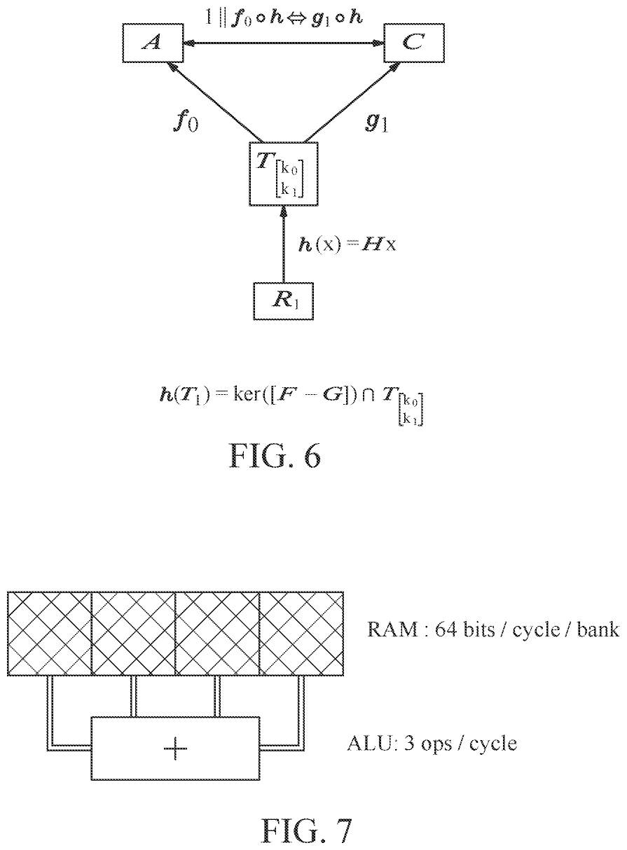

Computing the space T₁ along with the corresponding arrows (shown as an arrow from T₁ to Tₖ and another arrow from T₁ to Tₘ) (matrices) is equivalent to the KCA problem statement as depicted in FIG. 6.

Applying the KCA algorithm to the relations from our example, produces the result (full trace of the algorithm elided here):

$$[ 2 , 2 , 6 ] ( 2 a + b , c ) ⇔ ( a , 6 b + c )$$

Then, using this relation to fuse the loops results in this program:

```
  for (int i = 0; i < 2; ++i)
    for (int j = 0; j < 2; ++j)
      for (int k = 0; k < 6; ++k)
        F[i, 6*j + k] = A[2*i + j, k] * B[k] + C[6*j +
k];
```

This fused loop nest will execute up to four times as fast as the original program (assuming the loop bounds are replaced with sufficiently large numbers) since addition and multiplication are pipelined and the cache locality is dramatically improved.

### Example Application: Loop Fusion

A more detailed example of loop fusion is presented. Consider the following application program:

| A: tensor<10x200x1200> | |
|---|---|
| B: tensor<10x200x1> | |
| C = Multiply(A, B) | : tensor<10x200x1200> |
| D = Reshape(%C) | : tensor<2400000> |
| E = Reshape(%D) | : tensor<10x100x4x600> |
| F = ReduceSum(%E) | : tensor<10x100x600> |

Tensors C and F are the result of arithmetic operations, whereas D and E are the result of data movement operations. A less efficient compiler enables each operation directly as loops:

```
for (int h = 0; h < 10; ++h)
  for (int i = 0; i < 200; ++i)
    for (int j = 0; j < 1200; ++j)
      C = A[h, i, j] * B[h, i];
for (int i = 0; i < 2400000; ++i)
  D[i] = C[ x floordiv 240000,
          (x mod 240000) floordiv 1200,
            x mod 1200 ]
for (int i = 0; i < 10; ++i)
  for (int j = 0; j < 100; ++j)
    for (int k = 0; k < 4; ++k)
      for (int l = 0, l < 600; ++l)
        E[i, j, k, l] = D[240000 * x +
              2400 * y + 600 * z + w]
for (int h = 0; h < 10; ++h)
    for (int i = 0; i < 100; ++i)
        for (int j = 0; j < 600; ++j)
            for (int k = 0; k < 4; ++k)
            F[h, i, j] += E[h, i, k, j];
```

However, most compilers will avoid creating intermediate buffers to hold D and E. Therefore, we need to define a relation directly between the input of F (E) and the output of C. In polyhedral compilers, this is typically done via the use of affine maps, in this example:

```
D = alias(C :: (x) => (
    x floordiv 240000,
  (x mod 240000) floordiv 1200,
    x mod 1200 )
      )
E = alias(D :: (x, y, z, w) => (
  240000 * x + 2400 * y + 600 * z + w)
      )
```

Affine maps can be composed and simplified using the rules of Presburger arithmetic, yielding the following map from ‘E’ directly to ‘C’:

| E = alias(C :: (x, y, z, w) => ( | | |
|---|---|---|
| (240000 * x + 2400 * y + 600 * z + w) | floordiv | 240000, |
| ((2400 * y + 600 * z + w) mod 240000) | floordiv | 1200, |
| (600 * z + w) | mod | 1200) |

)

In contrast, using Lattice Images, these two relations would be represented in code as:

```
D = alias(C :: [10, 200, 1200]
  (x, y, z) <=> (2400 * x + 1200 * y + z))
E = alias(D :: [10, 100, 4, 600]
  (240000 * x + 2400 * y + 600 * z + w) <=> (x, y, z, w))
```

Composing these relations using KCA produces the following relation (explained in detail in the next section):

```
E = alias(C :: [10, 2, 100, 2, 600]
    (a, b + 2*c, 600*d + e) <=> (a, c, 2*b + d, e)
  )
```

Besides appearing much simpler visually, Lattice Image representation for the composed relation introduces several fewer variables into any ILP problem that involves it. If we introduce the Affine map into an ILP, using variables for each dimension of C and E, we would get the following constraint set:

| | |
|---|---|
| c0 = (240000 * e0 + 2400 * e1 + 600 * e2 + e3) | floordiv 240000 |
| c1 = ((2400 * e1 + 600 * e2 + e3) mod 240000 ) | floordiv |

1200

| | |
|---|---|
| c2 = (600 * e2 + e3) | mod |

1200

Since mod and floordiv cannot be included directly into an ILP, they must be expanded by creating separate variables for the quotient and remainder, as follows:

| | |
|---|---|
| 0 <= | r0 < 240000 |
| c0 * | 240000 + r0 = 240000 * e0 + 2400 * e1 + 600 * e2 + e3 |
| 0 <= | r1 < 1200 |
| q1 * | 1200 + r1 = r2 |
| 0 <= | r2 < 240000 |
| q2 * | 240000 + r2 = 2400 * e1 + 600 * e2 + e3 |
| c1 = | q1 |
| 0 <= | r3 < 1200 |
| q3 * | 1200 + r3 = 600 * e2 + e3 |
| c2 = | r3 |

It is typical to reduce the dimension of an ILP by eliminating equality constraints, which would result in:

```
0 <= 240000 * e0 + 2400 * e1 + 600 * e2 + e3 − c0 * 240000
  < 240000
0 <= 2400 * e1 + 600 * e2 + e3 − q2 * 240000 − c1 * 1200
  < 1200
0 <= 2400 * e1 + 600 * e2 + e3 − q2 * 240000
  < 240000
0 <= 600 * e2 + e3 − q3 * 1200
  < 1200
```

Note that there are 8 total variables in this ILP problem: e0 through e3, c0 and c1, q2 and q3.

Contrast this with an ILP formulation using the lattice image:

| | |
|---|---|
| 0 <= | r0 < 10 |
| 0 <= | r1 < 2 |
| 0 <= | r2 < 100 |
| 0 <= | r3 < 2 |
| 0 <= | r4 < 600 |
| c0 = | r0 |
| c1 = | r1 + 2*r2 |
| c2 = | 600*r3 + r4 |
| e0 = | r0 |
| e1 = | r2 |
| e2 = | 2*r1 + r3 |
| d3 = | r4 |

After eliminating equality constraints:

| | 0 <= c0 < 10 |
|---|---|
| 0 <= c1 − 2*e1 | < 2 |
| 0 <= e1 | < 100 |
| 0 <= r3 | < 2 |
| 0 <= e3 | < 600 |

Now, there are only 5 total variables in this problem: c0, c1, e1, e3 and r3.

Recall that the most efficient algorithms for solving an ILP have run-time exponential in the number of variables. Since most optimization problems on ML graphs (instruction scheduling, memory partitioning, etc.) can be framed as ILPs incorporating the read/write relations of the associated operations, lattice images can lead to a very dramatic speedup for these optimization tasks.

### Applying the KCA Algorithm

In the above example, we used KCA to combine the relations:

```
D = alias(C :: [10, 200, 1200]
  (x, y, z) <=> (2400 * x + 1200 * y + z))
E = alias(D :: [10, 100, 4, 600]
  (240000 * x + 2400 * y + 600 * z + w) <=> (x, y, z, w))
```

into one relation:

E = alias(C :: [10, 2, 100, 2, 600]
(a, b + 2*c, 600*d + e) <=> (a, c, 2*b + d, e)

Here we'll detail exactly how KCA computes this result. First, we apply the equality constraints implied by composing the two relations (x is a vector corresponding to the latent space of the first relation, y for the second relation, and T represents the Transpose operator):

[2400 1200 1]x·T=[240000 2400 600 1]y·T

This is equivalent to computing the null space (the subset of the relations that are mapped to zero) of the following matrix:

$$[ \begin{matrix}2400 & 1200 & 1 & - 240000 & - 2400 & - 600 & 1\end{matrix} ] [ \begin{matrix}x & y\end{matrix} ] . T = 0$$

A lattice basis of the null space can be computed using any existing algorithm, such as Hermite Normal Form or Smith Normal Form. KCA begins with this basis:

$$[ \begin{matrix}0 & 0 & 0 & 0 & 0 & 1\end{matrix} ]$$

$$[ \begin{matrix}1 & 0 & 0 & 0 & 0 & 0\end{matrix} ]$$

$$[ \begin{matrix}0 & 1 & 0 & 0 & 0 & 0\end{matrix} ]$$

$$[ \begin{matrix}0 & 0 & - 1 & 0 & 0 & 0\end{matrix} ]$$

$$[ \begin{matrix}0 & 0 & 0 & - 1 & 0 & 0\end{matrix} ]$$

$$[ \begin{matrix}0 & 0 & 0 & 0 & - 1 & 0\end{matrix} ]$$

$$[ \begin{matrix}1200 & 1 & 240000 & 2400 & 600 & 240000\end{matrix} ]$$

And the associated set of bounds, [10, 200, 1200, 10, 100, 4, 600]. Recall that KCA applies steps (1) validate candidate basis and (2) transform basis to incorporate missing vectors iteratively. Starting with step (1), we would first identify the following limits to each basis vector given the bounds:

$$\begin{matrix}lower & upper \\ [ 0 & 10 ] \\ [ 0 & 1 ] \\ [ 0 & 600 ] \\ [ 0 & 1 ] \\ [ 0 & 1 ] \\ [ 0 & 1 ]\end{matrix}$$

Next, we frame an ILP problem to solve for a vector defined by a lattice point inside these original bounds, but whose basis coefficients are not within the inferred limits:

$$\begin{matrix}vector & coefficients \\ [ 1 ] & [ 0 ] \\ [ 0 ] & [ 0 ] \\ [ 0 ] & [ - 1 ] \\ [ 1 ] & [ 0 ] \\ [ 0 ] & [ 0 ] \\ [ 0 ] & [ 0 ] \\ [ 0 ] & [ 1 ]\end{matrix} <= - 1 is not between [ 0 , 600 ]$$

In step (2), we apply unimodular matrices to incorporate this vector into our basis (see the first column):

$$[ \begin{matrix}1 & 0 & 0 & 0 & 1 & 0\end{matrix} ]$$

$$[ \begin{matrix}0 & 1 & 0 & 0 & 0 & 0\end{matrix} ]$$

$$[ \begin{matrix}0 & 0 & 0 & 1 & 0 & 0\end{matrix} ]$$

$$[ \begin{matrix}1 & 0 & 0 & 0 & 0 & 0\end{matrix} ]$$

$$[ \begin{matrix}0 & 0 & 0 & 0 & 0 & - 1\end{matrix} ]$$

$$[ \begin{matrix}0 & 2 & 1 & 0 & 0 & 0\end{matrix} ]$$

$$[ \begin{matrix}0 & 0 & - 600 & 1 & 240000 & 2400\end{matrix} ]$$

Repeating step (1) again produces the following new limits:

$$\begin{matrix}lower & upper \\ [ 0 & 10 ] \\ [ 0 & 2 ] \\ [ 0 & 1 ] \\ [ 0 & 600 ] \\ [ 0 & 1 ] \\ [ 0 & 1 ]\end{matrix}$$

And solving for a vector that disproves that this basis is complete produces the vector:

$$\begin{matrix}vector & coefficients \\ [ 0 ] & [ 0 ] \\ [ 2 ] & [ 2 ] \\ [ 0 ] & [ - 4 ] \\ [ 0 ] & [ 0 ] \\ [ 1 ] & [ 0 ] \\ [ 0 ] & [ 0 ] \\ [ 0 ] & [ - 1 ]\end{matrix} <= - 4 is not between [ 0 , 1 ]$$

Repeating step (2) again, we incorporate this vector into our basis:

$$[ \begin{matrix}1 & 0 & 0 & 0 & 0 & 1\end{matrix} ]$$

$$[ \begin{matrix}0 & 1 & 2 & 0 & 0 & 0\end{matrix} ]$$

$$[ \begin{matrix}0 & 0 & 0 & 0 & 1 & 0\end{matrix} ]$$

$$[ \begin{matrix}1 & 0 & 0 & 0 & 0 & 0\end{matrix} ]$$

$$[ \begin{matrix}0 & 0 & 1 & 0 & 0 & 0\end{matrix} ]$$

$$[ \begin{matrix}0 & 2 & 0 & - 1 & 0 & 0\end{matrix} ]$$

$$[ \begin{matrix}0 & 0 & 0 & 600 & 1 & 240000\end{matrix} ]$$

(You might notice the coefficients in the last row reducing in size after each iteration.) Repeating both steps once more produces the vector:

$$[ 0 ]$$

$$[ 0 ]$$

$$[ 600 ]$$

$$[ 0 ]$$

$$[ 0 ]$$

$$[ 0 ]$$

$$[ 0 ]$$

And incorporating it into the basis produces:

$$[ \begin{matrix}1 & 0 & 0 & 0 & 0\end{matrix} ]$$

$$[ \begin{matrix}0 & 1 & 2 & 0 & 0\end{matrix} ]$$

$$[ \begin{matrix}0 & 0 & 0 & 600 & 1\end{matrix} ]$$

$$[ \begin{matrix}1 & 0 & 0 & 0 & 0\end{matrix} ]$$

$$[ \begin{matrix}0 & 0 & 1 & 0 & 0\end{matrix} ]$$

$$[ \begin{matrix}0 & 2 & 0 & 1 & 0\end{matrix} ]$$

$$[ \begin{matrix}0 & 0 & 0 & 0 & 1\end{matrix} ]$$

At this point, step (1) terminates, because it is unable to find any more lattice points inside the bounds which are not a valid integer combination of the basis vectors. Note that we only need 5 vectors in the final basis, whereas the original basis had 6. The last vector of the transformed basis was not used (non-zero coefficient) for any lattice point in the bounded region, so it was removed. Each column of the basis corresponds to a latent variable of the composed relation (v=[a, b, . . . ].T), and each row to a dimension of the input or output, as such:

$$c 0 = [ \begin{matrix}1 & 0 & 0 & 0 & 0\end{matrix} ] v = a$$

$$c 1 = [ \begin{matrix}0 & 1 & 2 & 0 & 0\end{matrix} ] v = b + 2 * c$$

$$c 2 = [ \begin{matrix}0 & 0 & 0 & 600 & 1\end{matrix} ] v = 600 * d + e$$

$$e 0 = [ \begin{matrix}1 & 0 & 0 & 0 & 0\end{matrix} ] v = a$$

$$e 1 = [ \begin{matrix}0 & 0 & 1 & 0 & 0\end{matrix} ] v = c$$

$$e 2 = [ \begin{matrix}0 & 2 & 0 & 1 & 0\end{matrix} ] v = 2 * b + d$$

$$e 3 = [ \begin{matrix}0 & 0 & 0 & 0 & 1\end{matrix} ] v = e$$

See that each row corresponds to one of the expressions from the composed relation presented above:

$$[ 10 , 2 , 100 , 2 , 600 ] ( a , b + 2 ⋆ c , 600 * d + e ) \text{<=>} ( a , c , 2 ⋆ b + d , e ) )$$

While these optimization solutions can be used to generate code in the standard form of a nested loop/kernel (which is easier to depict above), on streaming processors such as the Groq TSP, later stages of the compiler generate intermediate representation language that gets compiler and assembled into flows of data that stream through processors without using a traditional loop structure. These optimization solutions allow all of the kernels to be optimized as one ‘unified’ kernel, instead of being mapped into a less efficient set of pre-optimized kernels as enabled in the prior art.

Such optimized data flows can eliminate the frequent loading/storing data to memory outside of the processor, which destroys latency, as does unnecessary data movements. For example, two kernels can be ‘fused’ by the methods disclosed herein to perform the same number of mathematical operations while eliminating large number of data transfers, which is more efficient on processors with limited amounts of processor (DRAM) memory.

### Example Application: Memory Bank Splitting

A common challenge in compiling AI models to hardware accelerators (e.g. FPGAs, ASICs, etc.) is sharding data sets (e.g. tensors) across multiple banks of SRAM in order to increase the saturation of ALUs reading data from those banks. Sharding is a process to partition tensors into subsets that can be operated upon more efficiently. Consider the following extremely simple processor architecture as depicted in FIG. 7.

There are 4 banks of memory (in one embodiment), each capable of reading one 64-bit value (e.g. FP64 number) per cycle, and one ALU capable of doing 3 FP64 additions per cycle. In order to fully saturate the ALU, the compiler needs to distribute data being summed is appropriately spread across the memory banks to feed the ALU.

Suppose the following ML graph is being compiled to this simple architecture:

| A: tensor<100x100> | |
|---|---|
| B = Reshape(A) | : tensor<50x2x50x2> |
| C = Transpose(B) | : tensor<50x50x2x2> |
| D = Reshape(C) | : tensor<50x50x4> |
| E = ReduceSum(D) | : tensor<50x50> |

This graph is a simplified expression of a tiled reduction across a 100×100 image face. Examining the ReduceSum operation alone, the compiler can determine that the memory be spread across the third dimension of D (of size 4). However, this is assuming that the preceding data movement operations have stored the result of D. Often this storage is inefficient, as opposed to a compiler fusing the data movement operations into a single loop nest. Using the loop fusion approach described above, this might result in:

```
for (int i = 0; i < 50; ++i)
  for (int j = 0; j < 50; ++j)
    for (int k = 0; k < 2; ++k)
      for (int l = 0; l < 2; ++l)
        E[i, j] += A[2*i + k, 2*j + l];
```

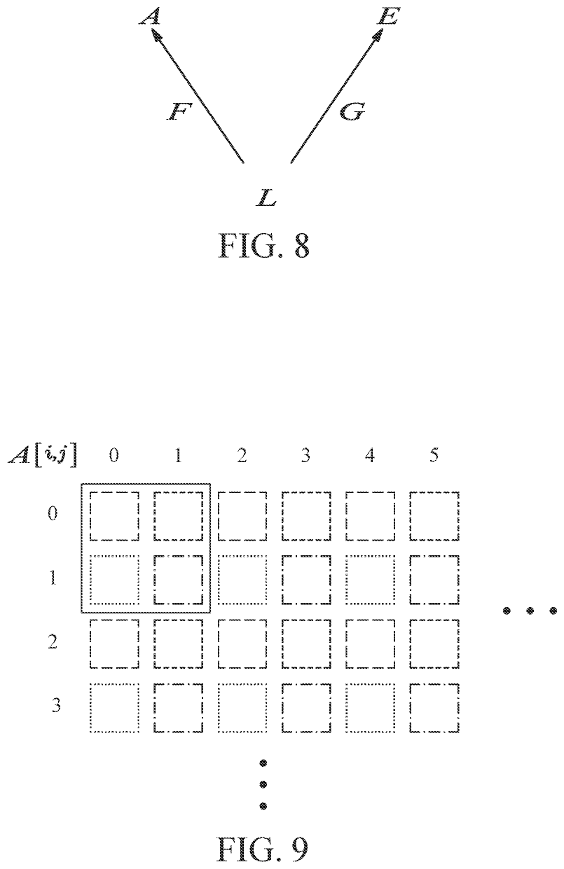

Since our loop nest is reading from A directly, a goal of the compiler is to ensure that all elements of A being reduced into a single element of E are on separate memory banks, so that they can be processed by the ALU simultaneously (assuming the memory bandwidth or capacity is inadequate to attempt to store back intermediate sums). Visually, this can be represented as a lattice relation as depicted in FIG. 8.

Specifically, the relation is:

$$[ 50 , 50 , 2 , 2 ] ( 2 a + c , 2 b + d ) ⇔ ( a , b )$$

The compiler needs to ensure that any points from A which are related to the same point in E are present on separate banks. The first step for the compiler is to characterize the set of loop iterations which touch the same element of E; e.g., the kernel of the map from L to E. Applying KCA to define this kernel within L gives:

$$ker ( G ) = [ \begin{matrix}0 & 0 \\ 0 & 0 \\ 1 & 0 \\ 0 & 1\end{matrix} ] [ \begin{matrix}2 \\ 2\end{matrix} ]$$

Where the first matrix is the computed kernel basis, and the second vector defines the bounds to each basis vector. Now, we know which loop iterations should access elements of A on separate banks. To translate this into a sharding pattern on A, we simply multiply each basis vector by F:

$$Fke r ( G ) [ \begin{matrix}1 & 0 \\ 0 & 1\end{matrix} ] [ \begin{matrix}2 \\ 2\end{matrix} ]$$

This result implies that that compiler should apply a strided pattern of 2 along both dimensions of A, visually as depicted in FIG. 9. Here, each different type of dotted lined square represents a different memory bank. Elements reduced to a single output pixel (surrounded by the large solid-lined box) all reside on separate memory banks.

### Introductory Overview to Tsp Architecture

Disclosed are configurations that include an integrated circuit with one or more deterministic processors (e.g., tensor streaming processors (TSPs) or artificial intelligence processors). Each may have a functional slice architecture. In some embodiments, each deterministic processor is configured to process a machine learning model. Each deterministic processor is divided into a plurality of functional units. The functional units are organized into a plurality of functional slices. Each functional slice is configured to perform specific functions within the deterministic processor. The deterministic processor may include memory functional slices (MEMs) for storing operand data, arithmetic functional slices for performing operations on received operand data (e.g., vector processing, matrix manipulation), and/or the like. Functional units of the deterministic processor are configured to stream operand data across a first (e.g., temporal) dimension in a direction indicated in a corresponding instruction, and receive instructions across a second (e.g., spatial) dimension. The compiler for the deterministic processor is aware of the hardware configuration of the processor and configures the timing of data and instruction flows such that corresponding data and instructions are intersected at each computational element at a predetermined time. Each functional slice of the deterministic processor may operate on a set of data lanes in a Single Instruction Multiple Data (SIMD) manner. The set of data lanes can be referred to herein as a “superlane” and represents a cross section of all the functional slices on a processor chip.

The disclosed embodiments are directed to a deterministic streaming processor having a functional slicing architecture. In some embodiments, the deterministic streaming processor may comprise a tensor streaming processor (TSP) having a functional slicing architecture, which may be used for hardware-accelerated machine learning (ML) applications.

The deterministic streaming processor (e.g., TSP) comprises a plurality of “computational elements,” each computational element corresponding to a functional unit within the processor. The on-chip memory and network-on-chip (NoC) of the processor architecture are fused to provide both storage of operands and results and may act as a conduit for transferring operand and/or result data to/from the functional units of the processor. The computational elements of the deterministic streaming processor are divided between different functionalities (e.g., memory, arithmetic operation, etc.), and are organized as functional slices which operate on multi-dimensional data (e.g., tensors). For example, each functional slice is composed of computational elements which border (or abut) each other, both horizontal and vertically, to form the functional slice. The number of computational elements and computation granularity of each computational element may be selected to take advantage of the underlying technology on which it is built. Taken together, the number of computational elements (N) and the word granularity (M) of a memory (e.g., static random-access memory (SRAM)) yields the vector length (VL) of the machine.

In some embodiments, each functional slice of the deterministic streaming processor functions independently and receives instructions from an instruction control unit (ICU). The ICU may pass instructions to a first computational element of the functional slice, which are then propagated in a first temporal dimension of the processor along the functional slice to the remaining computational elements of the functional slice. On the other hand, data operands for storage and/or processing may be passed between different functional slices of the deterministic streaming processor, in a second spatial dimension of the processor perpendicular to the first temporal dimension. As such, the data flow and the instruction flow of the deterministic streaming processor are separated from each other.

In some embodiments, a compiler for the deterministic streaming processor is aware of the hardware configuration of the deterministic streaming processor and synchronizes the timing of data and instruction flows such that corresponding data and instructions are received at each computational element with a predetermined temporal relationship (e.g., during the same clock cycle, separated by a predetermined delay, etc.). In some embodiments, the predetermined temporal relationship may be based upon the hardware of the deterministic streaming processor, a type of instruction, and/or the like. Because the temporal relationship between data and instructions are known by the compiler, the operand data received by a computational element does not include any metadata indicating what the data is to be used for. Instead, each computational element receives instructions, and based upon the predetermined timing, performs the instruction on the corresponding data. This allows for the data and instructions to flow through the deterministic streaming processor more efficiently.

The compiler may partition an Open Neural Network Exchange (ONNX) graph to get a subgraph that would run on a single chip. The compiler may run a Tensor Scheduler Analysis (TSA) to obtain estimated compute cycles. The TSA includes post-rewriting of ONNX operations to TSP operations while taking occupancies of a vector execution module (VXM), switch execution module (SXM) and matrix execution module (MXM) into account. The estimate of compute cycles assumes perfect scheduling. The estimated compute cycles can be combined with estimates of chip-to-chip (C2C) compute cycles for multichip performance estimate.

### Architectural Overview of Tensor Streaming Processor

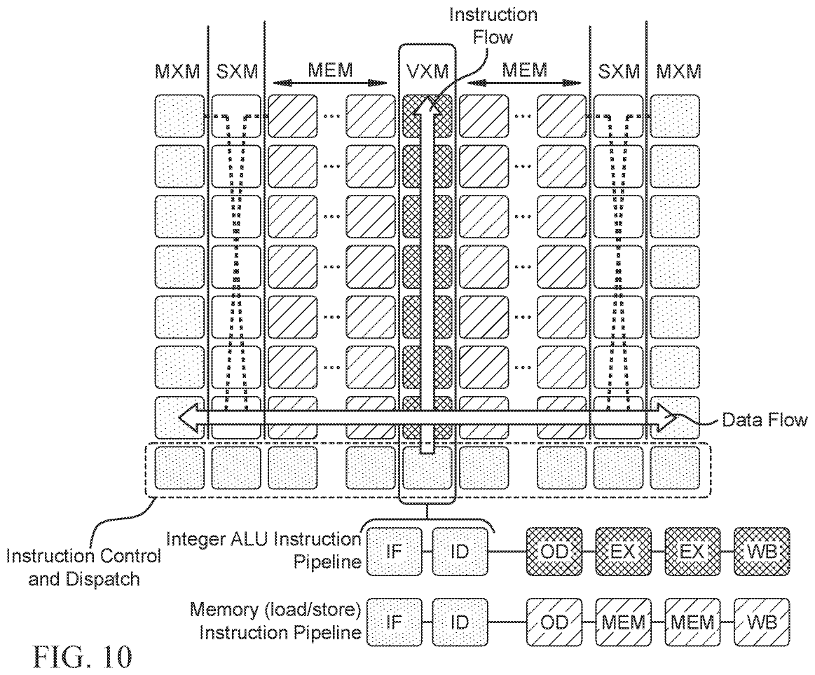

In accordance with embodiments of the present disclosure, the processor plane comprises a TSP, e.g., as may be commercially available from GROQ, INC. of Mountain View. California. It is to be understood that although many embodiments described herein use a TSP as the preferred processors, other deterministic processors may be used in commercial applications. FIG. 10 shows an arrangement of functional slices in a TSP, in accordance with some embodiments.

Certain core architectural elements set the TSP apart from GPU and accelerators. In a conventional chip multiprocessor (CMP), each “computational element” is an independent core that is interconnected using the on-chip network to exchange data between cores. Instruction execution is carried out over several stages: (i) instruction fetch (IF), (ii) instruction decode (ID), (iii) execution (EX) on Arithmetic Logic Units (ALUs), (iv) memory access (MEM), and (v) writeback (WB) to update the results in the general-purpose registers (GPRs).

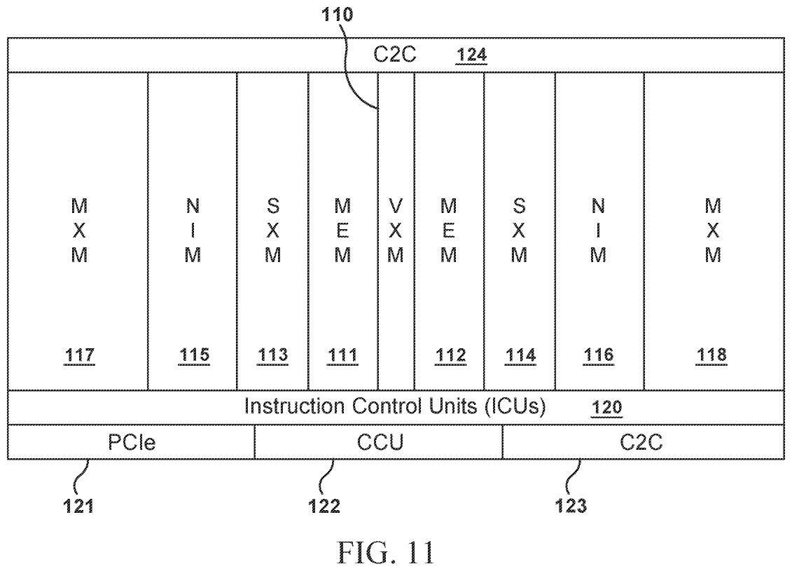

In contrast from conventional multicore, where each computational element is a heterogeneous collection of functional units but globally homogeneous, the TSP inverts that to have a local functional homogeneity but chip-wide (global) heterogeneity. Specifically, the TSP reorganizes the homogeneous two-dimensional mesh of cores into the functionally sliced microarchitecture shown in FIG. 11. In this approach, each computational element implements a specific function and is staked vertically into a specific “functional slice” in the Y-dimension of the two-dimensional on-chip mesh. The TSP disaggregates the basic elements of the conventional multicore per their respective functions: instruction control and dispatch (e.g., via instruction control unit (ICU)), memory (MEM), integer (INT) arithmetic, float point unit (FPU) arithmetic, and network (NET) interface, as shown by the functional slice labels at the top of FIG. 11. Each row of the two-dimensional on-chip mesh contains a cross section of all functional slices.

In this organization, each functional slice is independently controlled by a sequence of instructions specific to its on-chip role. For instance, the MEM functional slices support Read and Write but not, necessarily Add or Mul, which are typically performed in arithmetic functional slices (e.g., the vector execution module (VXM) and matrix execution module (MXM) functional slices) for some typical machine learning (ML) algorithms, such as the linear regression algorithm.

All functional slice's computational elements execute the same instruction stream-Single Instruction Multiple Data (SIMD) instructions. Thus, the common instruction decodes, and dispatch logic can be factored out into its own computational element (e.g., ICU) and decompose the normal instruction execution pipeline into two areas: (i) instruction fetch, decode, and parceling and (ii) operand read, execute, and writeback. This approach decouples the memory subsystem from the functional units retrieving their operands and depositing results.

In some embodiments, each functional slice implements, e.g., a 20-stage vector pipeline that spans the computational elements of each functional slice, with each computational element producing 16 elements of the 320-element maximum vector length. This organization naturally decomposes instruction flow in the vertical dimension, and data flow in the horizontal dimension as the data flow passes over different function types. With this processor organization, instruction execution is carried out by different computational elements: instruction fetching and decoding in the ICU and operand decode, execution and writeback at each computational element of the functional slice as the (vertical flowing) dispatched instruction intersects with the (horizontal flowing) operand data on which the dispatched instruction is operating. It will be appreciated that reference to ‘vertical’ and ‘horizontal’ or ‘north’, ‘south’, ‘east’ and ‘west’ are used in connection with the illustrations shown in the Figures, are abstractions that are solely intended to aid the reader and should not be inferred as technical limitations.

More specifically, FIG. 11 illustrates an example TSP 100, in accordance with some embodiments. The TSP 100 may include memory and arithmetic units optimized for multiplying and adding input data with weight sets (e.g., trained or being trained) for machine learning applications (e.g., training or inference). For example, the TSP 100 includes a VXM 110 for performing operations on vectors (e.g., one-dimensional arrays of values). Other elements of the system are arranged symmetrically on either side of the VXM 110 to optimize processing speed. For example, the VXM 110 is adjacent to MEMs 111-112, SXMs 113-114 to control routing of data, data domain and presentation controllers (or numerical interpretation modules (NIMs)) 115-116, and MXMs 117-118. An ICU 120 controls the flow of data and execution of operations across blocks 110-118, for example. The TSP 100 may further include communications circuits such as chip-to chip (C2C) circuits 123-124 and an external communication circuit (e.g., PCie) 121. The TSP 100 may, for example, further include a chip control unit (CCU) 122 to control boot operations, clock resets, and other low level setup operations.

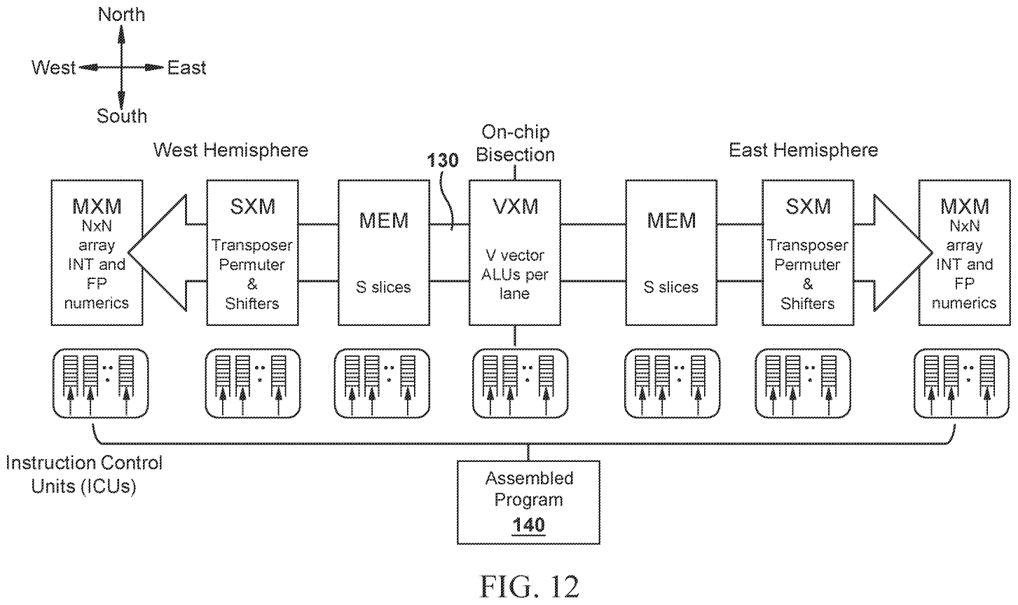

FIG. 12 illustrates organization and data flow within a row of the TSP 100, in accordance with some embodiments. As shown, each row of the two-dimensional on-chip mesh of the TSP 100 contains a cross section of all functional slices, e.g., N×N array of MXMs (e.g., N=320) configured for both integer (INT) and floating-point (FP) numeric (e.g., INT8 and FP16), S MEM functional slices (S=44), VXM functional slices with V vector ALUs per lane (e.g., V=16), and SXM functional slices. In this organization, each functional slice is independently controlled by a sequence of instructions specific to its on-chip role fetched by a corresponding array of ICUs (e.g., a total of ICUs=144 ICUs). Conceptually, the functional slices are fixed and data 130 are flowing across their computational elements. As the data flows through a specific functional slice, each functional slice can optionally intercept the data operands and compute a result (e.g., in case of MXM and VXM), or move data between data transport lanes on the network (e.g., in case of SXM and MEM). Instructions flow northward from the ICUs to the functional slices, while data (operands and results) primarily flow east and west between functional slices. Any inter-lane data movement within a vector uses the on-chip network functional slice.

It is noted that the “east-west-north-south” directionality is provided herein for ease of discussion and relativity. Furthermore, the “east-west-north-south” directionality is used as a reference for explanation of processing flow as described herein and is not intended to be limited with respect to a label of a particular direction. For example, north-south could be reoriented to east-west, and the principles currently described with east-west could apply to the reoriented north-south. In another example of the directionality not intended to be limited to the description per the reference noted, directionality could be referenced such that north-south is up-down and east west is right-left and the principles would accordingly apply.

In one embodiment, 320 lanes are overlaid on the TSP 100 where each computational element in the on-chip mesh operates on, e.g., 16-lanes in a SIMD manner. The 16-lane unit can be referred to herein as a “superlane” and represents a cross-section of all the functional slices on the chip. As such, a superlane may represent the architecture's minimum vector length (minVL) of, e.g., 16 elements. Likewise, the vertical composition of 20 tiles forming a functional slice may produce a maximum vector length (max VL) of, e.g., 20×16=320 functional units. Each of the 144 independent on-chip ICUs can issue one or more instructions per clock cycle. The compiler has explicit control of a program order in each instruction queue, e.g., by generating an assembled program 140 for execution by the ICUs and functional slices. There are 64 logical streams per lane for moving operands or results on-chip with, e.g., 32 streams eastward and 32 streams westward. The 220 MB of globally shared SRAM may deliver 32 bytes per lane of stream bandwidth and low-latency access to model parameters. For example, MEM can read and MXM can install more than e.g., 100,000 weights into a 320×320 array (e.g., 320 lanes×320 functional units) in less than 30 clock cycles including SRAM and on-chip network transit delays.

The MEM 111/112 and the SXM 113/114 provide deterministic routing of stream data as the stream data flows in the X and Y dimensions, respectively. With the TSP architecture 100, functional slices interact with streams of data in a producer-consumer fashion. That is, the functional slices consume operands from streams and produce results onto a (possibly different) stream, like an assembly line operator (functional slice) and conveyor belt (stream).

Conceptually, the functional slices are fixed, and data is flowing across computational elements. As the data flows through the functional slice, each computational element can optionally intercept the data operands and compute a result (if the computational element comprises an arithmetic logic unit (ALU)) or move data between lanes on the network if the computational element comprises a switching element.

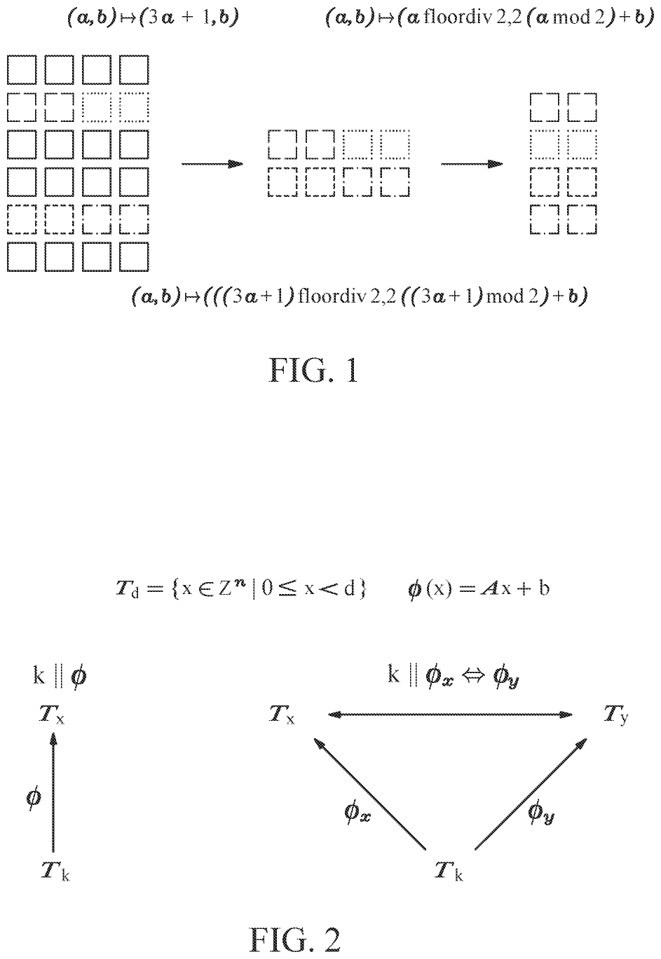

Streams provide a programming abstraction and are a conduit through which data flows between functional slices. Unlike GPRs, the functional slices operate on streams of parallel data flowing east or west (horizontally) across the chip. The horizontally flowing streams carrying operands intercept the vertically (northward) flowing instructions (see FIG. 1C) to perform a computation at a computational element on a functional slice. A compiler accurately maintains the chip's architectural state and uses that knowledge to ensure that instructions correctly intercept its stream operand(s).

Streams are implemented in hardware by a chip-wide streaming register file. Streams are architecturally visible and transport operands and results between functional slices. A common software pattern involves reading operand data from one or more MEM functional slices that is then subsequently consumed and operated on by a downstream arithmetic functional slice. The results of the operation are then produced onto another stream such that they can be written back to memory or passed to subsequent computational elements. For example, a Z=X+Y operation might require four instructions: Read SI, X and Read S2, Y are executed on two MEM functional slices and directed inward toward an ALU functional slice to perform the Add SI, S2, S3. Lastly, the result is stored back to memory via a Write S3, Z. The streams represent a collection of N's-elements, operated upon in a SIMD manner by each functional slice.

By way of example, a TSP architecture makes several deliberate tradeoffs on the hardware-software interface, pushing the complexities associated with scheduling into the compiler. Specifically, it falls on the compiler to precisely schedule instructions to use the hardware correctly and efficiently. At times this may involve selecting one of several means by which an algorithm or meta-operation may be realized on the hardware. Removing the control complexity of dynamic instruction scheduling for multi-issue execution units allows the ICU to be relatively small, accounting for, e.g., less than 3% of the chip area.

The compiler has access to, e.g., 320-lane programming abstraction overlaid on a TSP architecture where each computational element in the on-chip mesh operates on 16-lanes in a SIMD manner. The 16-lane unit can be referred to as a “superlane” which is a cross-section of all the functional slices on the chip and the minimum granularity of computation. As such, a superlane represents the architecture's minimum vector length, minVL, of 16 elements.

Likewise, the vertical composition of 20 tiles to form a functional slice produces a maximum vector length, max VL, of 20×16=320 elements.

The compiler has access to, e.g., 144 independent instruction queues (e.g., ICUs) on-chip: (a) six for westward MXM including two independent two-dimensional MAC (multiply accumulate) arrays; (b) 14 for westward SXM for intra-superlane and inter-Jane switching by rearranging elements of vectors; (c) 44 for westward MEM including 44 parallel functional slices of static random-access memory (SRAM); (d) 16 for VXM including 16 vector ALUs per lane; (e) 44 for eastward MEM-including 44 parallel functional slices of SRAM; (f) 14 for eastward SXM; and (g) six for eastward MXM including two independent two-dimensional MAC arrays, whereas each instruction queue can issue one or more instructions per cycle and the compiler has explicit control of the program order in each instruction queue.

The compiler has access to, e.g., 64 logical streams per lane. For example, 32 logical streams are required to operate on 16 minVL per lane for moving operands or results on-chip with 32 streams eastward, and 32 streams westward.

The compiler has access to, e.g., 220 Mibytes of globally shared SRAM that delivers 32 bytes per lane of stream bandwidth and low-latency access to model parameters. For example, MEM can read and MXM can install 400K weights into all four 320×320 arrays in less than 40 operational cycles including SRAM and on-chip network transit delay.

Streams are designated by both an identifier (0, . . . , 31) and direction. For example, in (28) designates stream 28 inward, and out (24) designates stream 24 toward the outward edge of the chip. The direction of a stream may be designated as inward (toward the chip bisection) or outward (toward the outward edge of the chip), or the direction may be designated as eastward or westward, (not shown).

The components of a superlane are organized spatially (not shown). The TSP's instruction set architecture (ISA) defines instructions spanning different functional areas. The partitioned global address space (PGAS) presented by the MEM functional slices provides memory semantics for vectors to be addressed from SRAM and loaded into an architecturally visible stream with a direction of dataflow toward the functional slice intending to operate on them.

The first functional area (e.g., ICU) provides explicit instruction fetching with IFetch instruction(s), and inter-slice synchronization using Sync and Notify instructions to perform chip-wide barrier synchronization among participating functional slices. A repeated-NOP (no op) instruction allows for precise cycle-by-cycle control of inter-instruction delay. For example, the compiler has cycle-accurate control when scheduling two operations A and B using an intervening NOP so that N cycles separate them, e.g., OpA NOP(N) OpB.

The second functional area (e.g., VXM) consists of a 4×4 mesh of ALUs in each lane for point-wise arithmetic operations.

The third functional area (e.g., MXM) consists of four independent two-dimensional MAC arrays that operate on, e.g., INT8 or FP16 data types.

On-chip data movement uses the fourth functional area (e.g., SXM) for intra-superlane and inter-lane switching by rearranging elements of vectors. The SXM is analogous to the NET interface to communicate between cores. Together the MEM and SXM work in tandem to form the X-Y dimensions of the on-chip network.

The fifth functional area (e.g., the east and west hemisphere of on-chip MEM module) is composed of 44 parallel MEM functional slices of SRAM and provides the memory access concurrency necessary to fully utilize the 32 streams in each East or West direction. Each functional slice provides 13-bits of physical addressing of 16-byte memory words, each byte maps to a lane, for a total of 220 Mibytes of on-chip SRAM.

An additional sixth functional area includes C2C modules configured to provide Send and Receive primitives for exchanging 320-byte vectors between a pair of TSP chips. One possible TSP implementation has, e.g., a total of 16×4 links operating at 30 Gbps each for a total off-chip bandwidth of 16×4×30 Gbps×2 directions=3.84 Tb/s (Terabytes per second) of off-chip pin bandwidth that can be flexibly partitioned to support high-radix interconnection networks of TSPs for large-scale systems. The host interface for peripheral component interconnect express (PCie) Gen4 may be also handled in this module. The host interface provides a lightweight direct memory access (DMA) engine to emplace a model onto the TSP memory and provides an entry point for bootstrapping the model execution.

The host interface also provides a general mechanism for passing interrupts to the host, which may be necessary in the event a multi-bit memory error is observed, for example. A sequence of instructions performed on different functional slices can be chained to create more complex actions without the need to write back intermediate results to memory.

This allows efficient processing of streams at full bandwidth and lowest latency.

Machine learning algorithms typically operate on vectors with coefficients of a specified data type (e.g., INT8, FP16, etc.). These vectors may be interpreted as an abstraction over the underlying data, whose elements can be processed by the same operation in a SIMD manner. The TSP operates on vectors, sometimes organized into rank-2 tensors, and relies on the graph-lowering compiler to transform higher rank tensors into rank-2 tensors.

The TSP's programming model is a producer-consumer model where each functional slice acts as a consumer and a producer of one or more streams. When a vector is read from a main memory, the vector is given a stream identifier (0, . . . , 31) and direction: eastward, or westward. Once the vector is read into a stream register it is a stream and is “flowing” in the given direction in the following sense given spatially adjacent functional slices at coordinates xo, x1, x2 (where the spatial coordinate increases in the direction of flow), then at a given time ti, the vector representing stream s1 at functional slice x1 can be accessed as operands by that functional slice. Similarly, the functional slices at xo and x2 will have access to different stream values for the same stream register. In the following cycle (H1, the value s1 either propagated to the functional slice at x2, or else the value s1 is overwritten with a result n produced by the functional slice at x1 at cycle t. Similarly, the stream value so that was present to be consumed by the functional slice at coordinate xo at time ti will be (absent xo overwriting the value at time ti) available in the next cycle tH1 to the functional slice at xi. Stream operands are steered toward the functional slice that is consuming them and producing a result stream. Streams are constantly flowing across the chip, serving as how functional slices communicate with one another.

In the TSP programming model, an instruction is issued on a functional slice at a given compiler-scheduled time t and executes as a SIMD operation on stream-supplied operand vectors (e.g., of up to 320-elements), producing vectors of the same length on result streams. For example, at the micro-architectural level, the 320-element SIMD instruction is pipelined across the vertical stack of computational elements in the functional slice. That is, at the scheduled time t, the instruction would be issued to the bottom-most computational element of the functional slice, e.g., corresponding to the first 16-element superlane of operand/result vectors. In the subsequent operational cycle, the instruction would be propagated to the next computational element northward in the functional slice, which in turn executes the instruction on the next 16-element super lane of operand vectors. This process continues cycle-by-cycle until the process has traversed, e.g., all 20 computational elements in the functional slice. The combination of vertical instruction pipelining described above, along with the need for operands and instructions to coincide at a precise time, results in a spatial “stagger” of SIMD operand and result data.

### Example Computer System Architecture

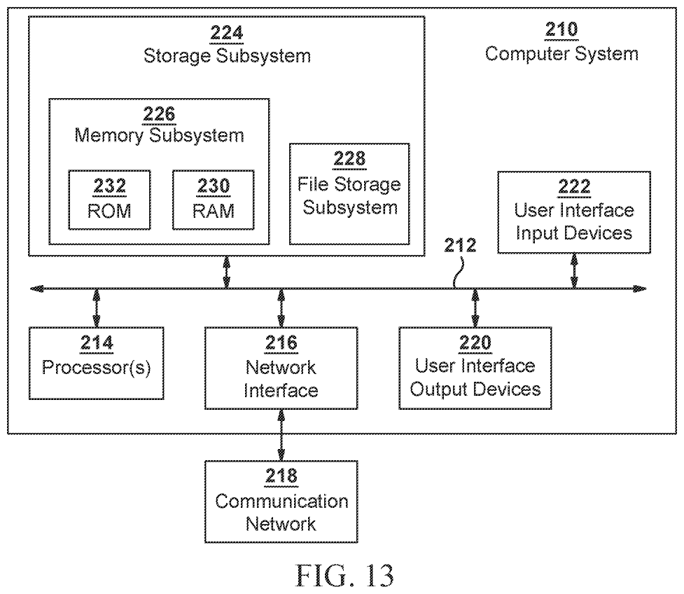

FIG. 13 is an abstract diagram of an example computer system suitable for enabling embodiments of the claimed disclosures, in accordance with some embodiments.

In FIG. 13, the structure of computer system 210 typically includes at least one computer 214 which communicates with peripheral devices via bus subsystem 212. Typically, the computer includes a processor (e.g., a microprocessor, graphics processing unit, or digital signal processor), or its electronic processing equivalents, such as an ASIC or FPGA. Typically, peripheral devices include a storage subsystem 224, comprising a memory subsystem 226 and a file storage subsystem 228, user interface input devices 222, user interface output devices 220, and/or a network interface subsystem 216. The input and output devices enable direct and remote user interaction with computer system 210. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, for example, MICROSOFT WINDOWS, APPLE MACOS and IOS, GOOGLE ANDROID, Linux and/or Unix. The computer system typically includes a Basic Input/Output System (BIOS) and processor firmware. The operating system, BIOS and firmware are used by the processor to structure and control any subsystems and interfaces connected to the processor. Example processors that enable these operating systems include: the Pentium, Itanium, and Xeon processors from INTEL; the Opteron and Athlon processors from AMD (ADVANCED MICRO DEVICES); the Graviton processor from AMAZON; the POWER processor from IBM; the SPARC processor from ORACLE; and the ARM processor from ARM Holdings.

Any embodiment of the present disclosure is limited neither to an electronic digital logic computer structured with programs nor to an electronically programmable device. For example, the claimed embodiments can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 210 depicted in FIG. 54 is intended only as an example. Many other structures of computer system 210 have more components than the computer system depicted in FIG. 13.

Network interface subsystem 216 provides an interface to outside networks, including an interface to communication network 218, and is coupled via communication network 218 to corresponding interface devices in other computer systems or machines. Communication network 218 can comprise many interconnected computer systems, machines and physical communication connections (signified by ‘links’). These communication links can be wireline links, optical links, wireless links (e.g., using the Wi-Fi or Bluetooth protocols), or any other physical devices for communication of information. Communication network 218 can be any suitable computer network, for example a wide area network such as the Internet, and/or a local to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or Integrated Services Digital Network (ISDN)), (asynchronous) digital subscriber line (DSL) unit, Firewire interface, universal serial bus (USB) interface, and the like. Communication algorithms (‘protocols’) can be specified using one or communication languages, such as Hypertext Transfer Protocol (HTTP), Transmission Control Protocol/Internet Protocol (TCP/IP), Real-time Transport Protocol/Real Time Streaming Protocol (RTP/RTSP), Internetwork Packet Exchange (IPX) protocol and/or User Datagram Protocol (UDP).

User interface input devices 222 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 210 or onto communication network 218. User interface input devices typically enable a user to select objects, icons, text and the like that appear on some types of user interface output devices, for example, a display subsystem.

User interface output devices 220 can include a display subsystem, a printer, a fax machine, or a non-visual communication device such as audio and haptic devices. The display subsystem can include a CRT, a flat-panel device such as an LCD, an image projection device, or some other device for creating visible stimuli such as a virtual reality system. The display subsystem can also provide non-visual stimuli such as via audio output, aroma generation, or tactile/haptic output (e.g., vibrations and forces) devices. Typically, the term ‘output device’ signifies all possible types of devices and processes to transfer data and information out of computer system 210 to the user or to another machine or computer system.

Such devices are connected by wire or wirelessly to a computer system. Note that some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 226 typically includes several memories including a main RAM 230 (or other volatile storage device) for storage of instructions and data during program execution and a ROM 232 in which fixed instructions are stored. File storage subsystem 228 provides persistent storage for program and data files, and can include a hard disk drive, a floppy disk drive along with associated removable media, a CD-ROM drive, an optical drive, a flash memory such as a USB drive, or removable media cartridges. If computer system 210 includes an input device that performs optical character recognition, then text and symbols printed on a physical object (such as paper) can be used as a device for storage of program and data files.

The databases and modules used by some embodiments can be stored by file storage subsystem 228.

Bus subsystem 212 provides a device for transmitting data and information between the various components and subsystems of computer system 210. Although bus subsystem 212 is depicted as a single bus, alternative embodiments of the bus subsystem can use multiple buses. For example, a main memory using RAM can communicate directly with file storage systems using DMA systems.

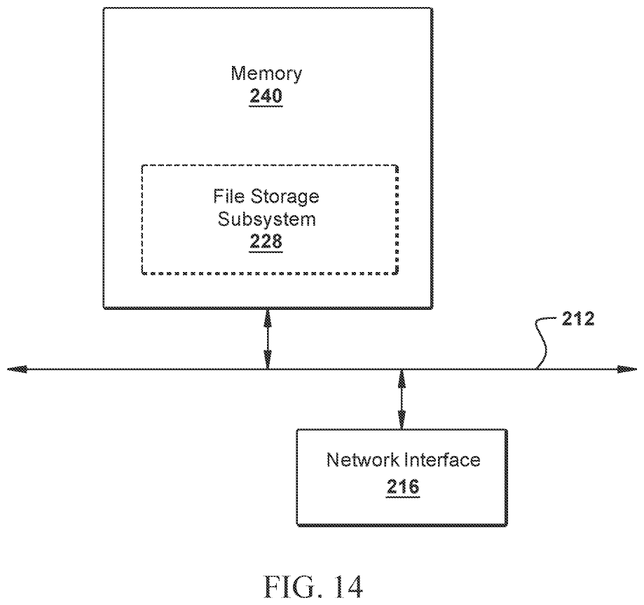

FIG. 14 is another abstract diagram of a computer system suitable for enabling embodiments of the claimed disclosures, in accordance with some embodiments. FIG. 14 depicts a memory 240 such as a non-transitory, processor readable data and information storage medium associated with file storage subsystem 228, and/or with network interface subsystem 216 (e.g., via bus subsystem 212), and can include a data structure specifying a circuit design. The memory 240 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### Additional Example Computing System

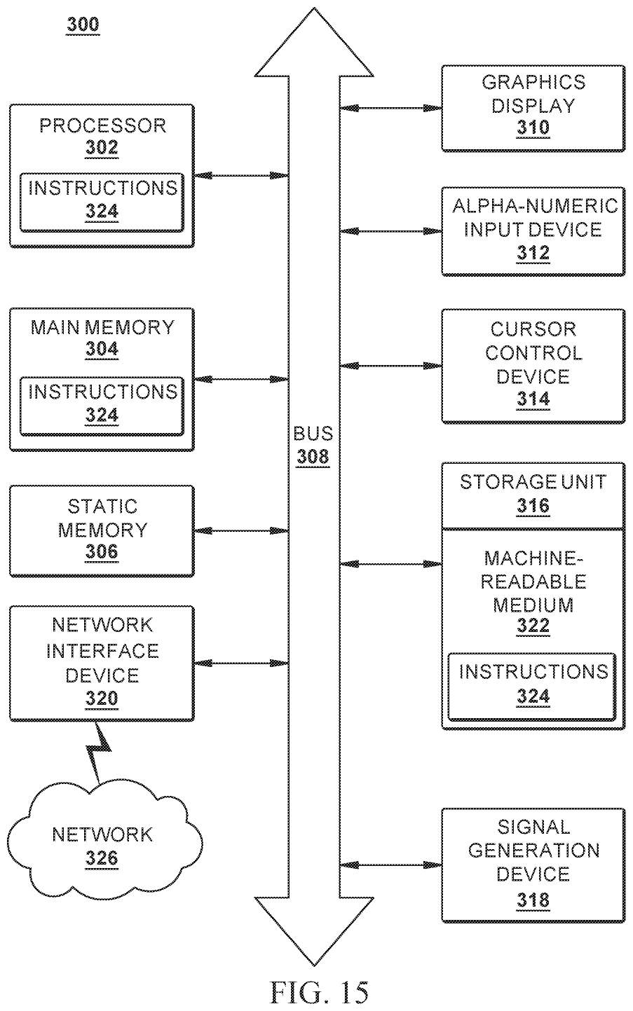

FIG. 15 is a block diagram illustrating components of an example computing machine that is capable of reading instructions from a computer-readable medium and executing them in a processor (or controller) according to an embodiment. A computer described herein may include a single computing machine, a virtual machine, a distributed computing system that includes multiple nodes of computing machines, or any other suitable arrangement of computing devices. The computer described herein may be used by any of the elements described in the previous figures to execute the described functions.

By way of example, FIG. 15 depicts a diagrammatic representation of a computing machine in the example form of a computer system 300 within which instructions 324 (e.g., software, program code, or machine code), which may be stored in a computer-readable medium, causing the machine to perform any one or more of the processes discussed herein. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 15 may correspond to any software, hardware, or combined components shown in the figures above. By way of example, a computing machine may be a tensor streaming processor designed and manufactured by GROQ, INC. of Mountain View, California, a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 324 that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 300 includes one or more processors (generally, a processor 302) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308.

The computer system 300 may further include graphics display unit 310 (e.g., a plasma display panel (PDP), a liquid crystal display (LCD), a projector, or a cathode ray tube (CRT)). The computer system 300 may also include alphanumeric input device 312 (e.g., a keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a computer-readable medium 322 on which the instructions 324 are stored embodying any one or more of the methodologies or functions described herein. The instructions 324 may also reside, completely or at least partially, within the main memory 304 or within the processor 302 (e.g., within a processor's cache memory). Thus, during execution thereof by the computer system 300, the main memory 304 and the processor 302 may also constitute computer-readable media. The instructions 324 may be transmitted or received over a network 326 via the network interface device 320.

While the computer-readable medium 322 is shown in an example embodiment to be a single medium, the term “computer-readable medium” should be taken to include a single medium or multiple media (e.g., a centralized or distributed database, or associated caches and servers) able to store instructions (e.g., the instructions 324). The computer-readable medium 322 may include any medium that is capable of storing instructions (e.g., the instructions 324) for execution by the machine and that causes the machine to perform any one or more of the methodologies disclosed herein. The computer-readable medium 322 may include, but not be limited to, data repositories in the form of solid-state memories, optical media, and magnetic media. The computer-readable medium 322 does not include a transitory medium such as a signal or a carrier wave.

### Example of a Compiler

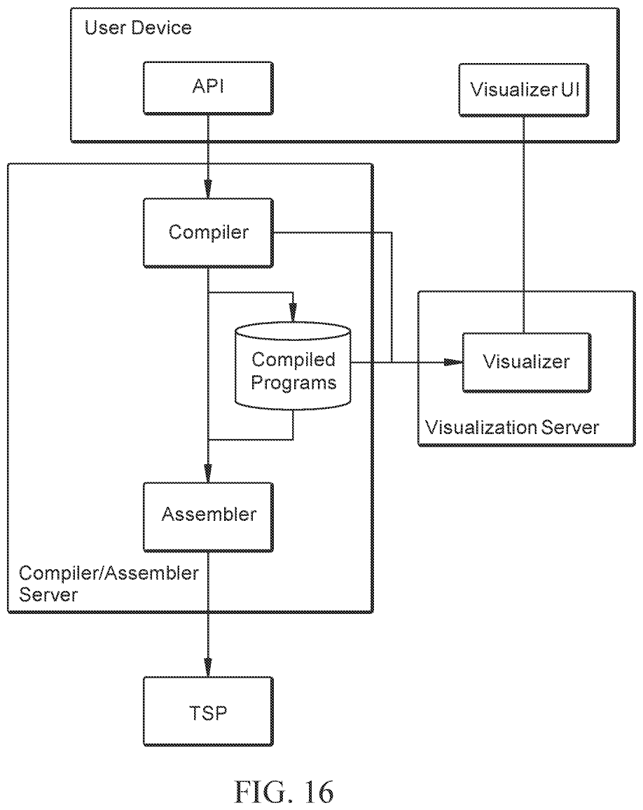

FIG. 16 illustrates a system 1600 for compiling programs to be executed on a tensor processor, and for generating power usage information for the compiled programs, according to an embodiment. The system 1600 includes a user device 1602, a server 1610, and a processor 1620. Each of these components, and their sub-components (if any) are described in greater detail below. Although a particular configuration of components is described herein, in other embodiments the system 1600 have different components and these components perform the functions of the system 1600 in a different order or using a different mechanism. For example, while FIG. 16 illustrates a single server 1610, in other embodiments, compilation, assembly, and power usage functions are performed on different devices. For example, in some embodiments, at least a portion of the functions performed by the server 110 are performed by the user device 1602.

The user device 1602 comprises any electronic computing device, such as a personal computer, laptop, or workstation, which uses an Application Program Interface (API) 1604 to construct programs to be run on the processor 1620. The server 110 receives a program specified by the user at the user device 1602 and compiles the program to generate a compiled program 1614. In some embodiments, a compiled program 1614 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 1612 is a TensorFlow compiler and the processor 1620 is a tensor processor. In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 1620 is a tensor processor having a functional slice architecture, the compiler 1612 generates an explicit plan for how the processor will execute the program, by translating the program into a set of operations that are executed by the processor 1620, specifying when each instruction will be executed, which functional slices will perform the work, and which stream registers will hold the operands. This type of scheduling is known as “deterministic scheduling”. This explicit plan for execution includes information for explicit prediction of excessive power usage by the processor when executing the program.

The assembler 1616 receives compiled programs 1614, generated by the compiler 1612, and performs final compilation and linking of the scheduled instructions to generate a compiled binary. In some embodiments, the assembler 1614 maps the scheduled instructions indicated in the compiled program 1612 to the hardware of the server 1610, and then determines the exact component queue in which to place each instruction.

The processor 1620, e.g., is a hardware device with a massive number of matrix multiplier units that accepts a compiled binary assembled by the assembler 1616, and executes the instructions included in the compiled binary. The processor 1620 typically includes one or more blocks of circuitry for matrix arithmetic, numerical conversion, vector computation, short-term memory, and data permutation/switching. One such processor 1620 is a tensor processor having a functional slice architecture as described above. In some embodiments, the processor 1620 comprises multiple tensor processors connected together.

### Additional Considerations

The disclosed configurations may have benefits and advantages that include, for example, a more efficient data flow by separating the functions of the processor into specialized functional units and configuring the timing of data and instructions to each functional unit, such that each unit is able operate on received data based upon a known timing between received data and instructions. Because the compiler for the processor is hardware aware, it is able to configure an explicit plan for the processor indicating how and when instructions and data operands are transmitted to different tiles of the processor. By accounting for the timing of received instructions and data, the data can be transmitted between the tiles of the processor without unnecessary metadata, increasing the efficiency of the transmission. In addition, by separating the transmission of data and instructions, instructions can be iterated and looped independent of received data operands.

In addition, because each computational element of the processor is dedicated to a specific function (e.g., MEM, VXM, MXM, SXM), the number of instructions needed to be processed by the computational elements may be reduced. For example, certain computational elements (e.g., in MXM functional slice) may be configured to perform a limited set of operations on any received data. As such, these computational elements may be able to operate without having to receive explicit instructions or only receiving intermittent or limited instructions, potentially simplifying operation of the processor. For example, data operands read from memory can be intercepted by multiple functional slices as the data is transmitted across a data lane, allowing for multiple operations to be performed on the data in a more efficient manner.

In operation, a host computer programs a DMA engine to actually transfer data, again all of which is coordinated by the runtime layer. Specifically, the IDU transfers 320-byte vectors from PCie-Gen4 32-bytes every core-clock cycle (e.g., nominal 900 Mhz). Thus, the 320-element vector arrives over a period of 10 cycles and placed on multiple streams moving towards the MEM. The incoming streams flow on S24-31 (upper eight streams), from which the MEM performs a “write” to commit that vector to SRAM. Hence, a PCI-Receive consists of (i) receiving the data from the PCI interface, and (ii) writing the vector into the specified functional slice of the MEM.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or maybe architectures employing multiple processor designs for increased computing capability.

Some embodiments of the present disclosure may further relate to a system comprising a processor (e.g., a tensor streaming processor or an artificial intelligence processor), at least one computer processor (e.g., a host server), and a non-transitory computer-readable storage medium. The storage medium can store computer executable instructions, which when executed by the compiler operating on the at least one computer processor, cause the at least one computer processor to be operable for performing the operations and techniques described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A compiler process that reduces the number of variables in a program code representing relations of operations across long chains of tensor program operations such that the use of kernels at the lowest levels of program compilation can be eliminated, the process comprising a lattice image data structure for representing these relations in a tensor program code, and an algorithm that combines these relations while minimizing dimensionality of the integer sets and lattice images.

2. The compiler of claim 1 wherein the algorithm is a KCA algorithm.

3. The compiler of claim 2, wherein the KCA algorithm infers a low-dimensional shape of points from the hidden dimension set to reduce the hidden dimension of the resulting set or relation.

4. The compiler of claim 2, wherein the KCA algorithm iteratively modifies the starting lattice basis until a desired property is achieved.

5. The compiler of claim 2, wherein the KCA algorithm is run iteratively to validate a candidate shape or find missing points and to use missing points to improve the lattice basis.

6. A method of using a loop fusion by a compiler in interconnected accelerator units to simplify a machine learning (ML) graph representing a program to be compiled, said method comprising:
(A) lowering a plurality of operation in said initial first program to an original plurality of at least two loops;
and
(B) inferring a fused loop structure from said original plurality of at least two loops in said initial first program thus creating a second program having said fused loop, wherein said fused loop in said second program is pipelining the multiplication and addition operations thus significantly reducing the memory bandwidth requirements and improving cache locality.

7. The method of claim 6, wherein said interconnected accelerator units are selected from the group consisting of: a computer chip; a TSP chip; and a GROQ chip.

8. The method of claim 6, wherein said step (B) further comprises:
(B1) expressing indexing logic in said original plurality of loops in said initial first program as lattice relations.

9. The method of claim 7, wherein said step (B1) further comprises:
(B1, 1) calculating the hidden dimensions of the bijection between the iteration spaces of at least two initial loops.

10. The method of claim 8, wherein said step (B1, 1) further comprises:
(B1, 1, 1) applying Kernel Characterization Algorithm (KCA) to said lattice relations.

11. The method of claim 10, wherein said KCA algorithm infers a low-dimensional shape of points from said hidden dimension set, thus reducing the hidden dimension of the resulting set or relation.

12. The method of claim 10, wherein said KCA algorithm comprises the following steps:
(C) validating a candidate lattice basis;
and
(D) using the missing points to improve said candidate lattice basis.

13. The method of claim 12, wherein said step (C)) further comprises:
(C1) using Integer Linear Programming to validate said candidate lattice basis.

14. An apparatus enabling a compiler in interconnected accelerator units to simplify a machine learning (ML) graph representing a program to be compiled, said method comprising:
(A) a means for lowering a plurality of operations in an initial first program to an original plurality of at least two loops;
and
(B) a means for inferring a fused loop structure from said original plurality of at least two loops in said initial first program thus creating a second program having said fused loop, wherein said fused loop in said second program is pipelining the multiplication and addition operations thus significantly reducing the memory bandwidth requirements and improving cache locality.

15. The apparatus of claim 14, wherein aid mean (B) further comprises:
(B1) a Kernel Characterization Algorithm (KCA) configured to calculate the hidden dimensions of the bijection between the iteration spaces of at least two initial loops.
